(19) United States
(12) Patent Application Publication
(10) Pub. No.: US 2009/0254386 A1
(43) Pub. Date: Oct. 8, 2009

(54) INNOVATION MARKET

(75) Inventors: Esther Wang, Redmond, WA (US); Howard Alexander Hurst, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/060,871

(22) Filed: Apr. 2, 2008

(51) Int. Cl. G06Q 10/00

(52) U.S. Cl. 705/7

(57) ABSTRACT

An innovation market is described. An apparatus may comprise an innovation market subsystem arranged to manage an innovation marketplace for the exchange of virtual shares in a project for virtual currency to measure project value. The innovation market subsystem may comprise an innovator manager module operative to allocate virtual shares to a project. The innovation market subsystem may also comprise an innovation exchange module communicatively coupled to the project manager module, the innovation exchange module operative to exchange virtual shares for virtual currency at a virtual market price. The innovation market subsystem may further comprise a price generator module communicatively coupled to the innovation exchange module, the price generator module operative to modify the virtual market price for the project based on the exchange. The innovation market subsystem may still further comprise an investor manager module communicatively coupled to the price generator module, the inventor manager module operative to generate a project value for an investor by multiplying the virtual market price for the virtual shares and a number of virtual shares owned by the investor. Other embodiments are described and claimed.

### BACKGROUND

Many individuals in an organization have various ideas for projects for the organization. In many cases, however, an individual may be unable to create sufficient interest in a project for the organization to commit resources to the project. Similarly, an organization may be unable to understand whether a given project can assist in achieving the various goals of the organization. Consequently, it may be desirable to create an objective measurement of project value that may be used as a basis for determining whether to include the project in a project planning. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one embodiment, an apparatus may comprise an innovation market subsystem arranged to manage an innovation marketplace for the exchange of virtual shares in a project for virtual currency to measure project value. The innovation market subsystem may comprise an innovator manager module operative to allocate virtual shares to a project. The innovation market subsystem may also comprise an innovation exchange module communicatively coupled to the project manager module, the innovation exchange module operative to exchange virtual shares for virtual currency at a virtual market price. The innovation market subsystem may further comprise a price generator module communicatively coupled to the innovation exchange module, the price generator module operative to modify the virtual market price for the project based on the exchange. The innovation market subsystem may still further comprise an investor manager module communicatively coupled to the price generator module, the inventor manager module operative to generate a project value for an investor by multiplying the virtual market price for the virtual shares and a number of virtual shares owned by the investor. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a network.

FIG. 2 illustrates an embodiment of an innovation market subsystem.

FIG. 3 illustrates an embodiment of an innovation market.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments are generally directed to innovation market techniques. Some embodiments are particularly directed to techniques to create and manage a public or private innovation market exchange for projects to facilitate measurement or prediction of project value to an organization, such as a business entity. In one embodiment, for example, an electronic network may include an innovation market server node having a computing system and a communications system. The computing system may implement an innovation market subsystem to manage an innovation market for the exchange of virtual shares in a project for virtual currency to measure project value.

The innovation market may in some respects resemble or model a stock market. A stock market is a private or public market for the trading of company stock and derivatives of company stock at an agreed price. Similarly, the innovation market may comprise a private or public market for the trading of “virtual shares” and derivatives of “virtual shares” for a project at an agreed price. Rather than using real shares or real currency that represents financial or monetary units of measurement, however, the innovation market utilizes “virtual shares” and “virtual currency.” The virtual shares and the virtual currency used as a basis for trading in the innovation market represent non-monetary units of measurement that have no corresponding financial or monetary value, but rather are intended to generate an objective measurement of project value to an organization, organization member, or community of organization members. The project value may then be used, among other use scenarios, as a basis for determining whether to include the project in a project planning. Furthermore, the innovation market techniques may create a community or social network of organization members acting in the roles of innovators and investors, thereby refining, growing and enhancing overall project planning for organizations. Having a larger community or social network of organization members, with each member contributing projects that potentially impact a set of goals for the organization, allows an organization to have a deeper and more robust understanding of the markets they serve. As a result, an organization may align targeted projects with organizational goals to better serve such markets, and in some respects, the organization members themselves.

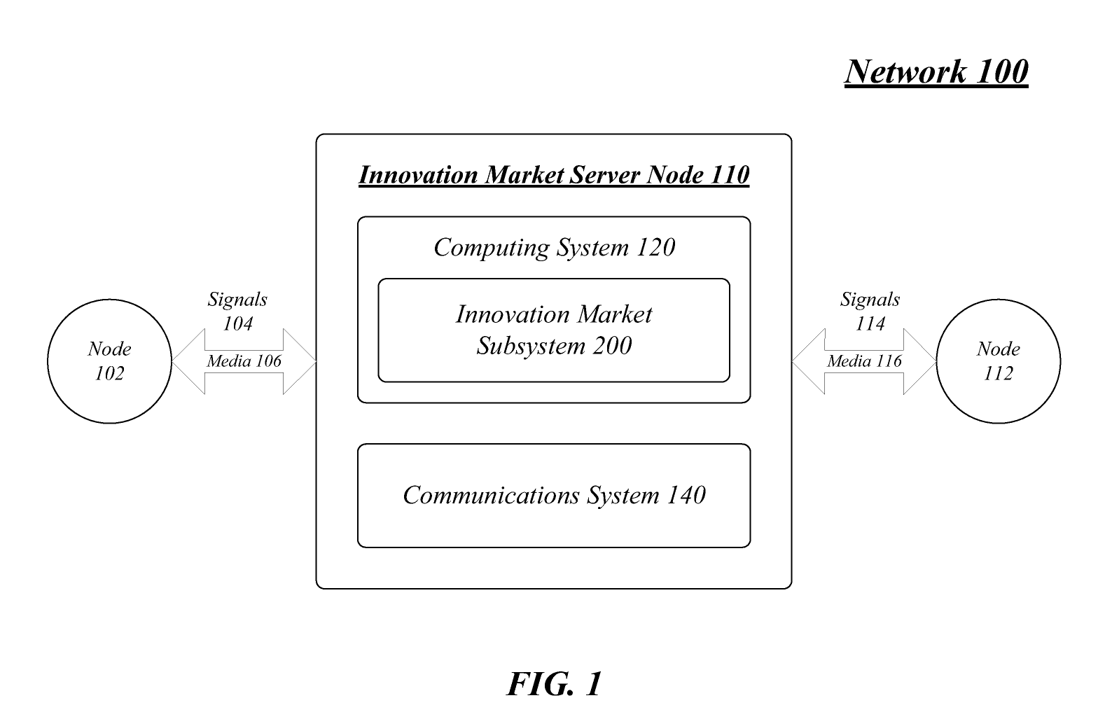

FIG. 1 illustrates a block diagram for a network 100. The network 100 may comprise various elements designed for implementation by a single entity environment or a multiple entity distributed environment. Each element may be implemented as a hardware element, software element, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof.

As used herein the terms “system,” “subsystem,” “component,” and “module” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the network 100 may comprise, among other elements, multiple nodes 102, 110 and 112. A node generally may comprise any electronic device designed for managing, processing or communicating information in the network 100. Examples for a node may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the network 100 as shown in FIG. 1 has a limited number of nodes in a certain topology, it may be appreciated that the network 100 may include more or less nodes in alternate topologies as desired for a given implementation.

The nodes 102, 112 may be communicatively coupled to a node 110 via respective communications media 106, 116. The nodes 102, 110, 112 may coordinate operations between each other. The coordination may involve the unidirectional or bi-directional exchange of information. For instance, the nodes 102, 112 may communicate information with node 110 in the form of respective signals 104, 114 communicated over the respective communications media 106, 116. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In various embodiments, the node 110 may be implemented as an innovation exchange server node 1 10. The innovation exchange server node 110 may comprise any logical or physical entity that is arranged to implement various innovative market techniques as described herein. When implemented as an innovation exchange server node 110, the nodes 102, 112 may be implemented as client nodes 102, 112 having the appropriate application programs, such as web browsers, to communicate and interoperate with the innovation exchange server node 110.

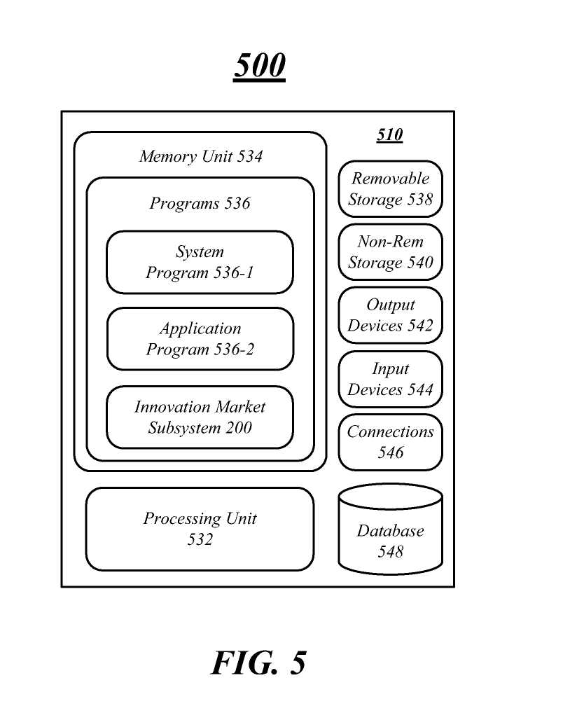

The innovation exchange server node 110 may comprise a computing system 120 and a communications system 140. The computing system 120 includes various common computing elements, such as one or more processors, co-processors, memory units, chipsets, controllers, peripherals, interfaces, oscillators, timing devices, video cards, audio cards, multimedia input/output (I/O) components, and so forth. The communications system 140 includes various common communications elements, such as a transmitter, receiver, transceiver, radio, network interface, baseband processor, antenna, amplifiers, filters, and so forth. In one embodiment, for example, the innovation exchange server node 110 may be implemented using a computing and communications architecture as described with reference to FIG. 5.

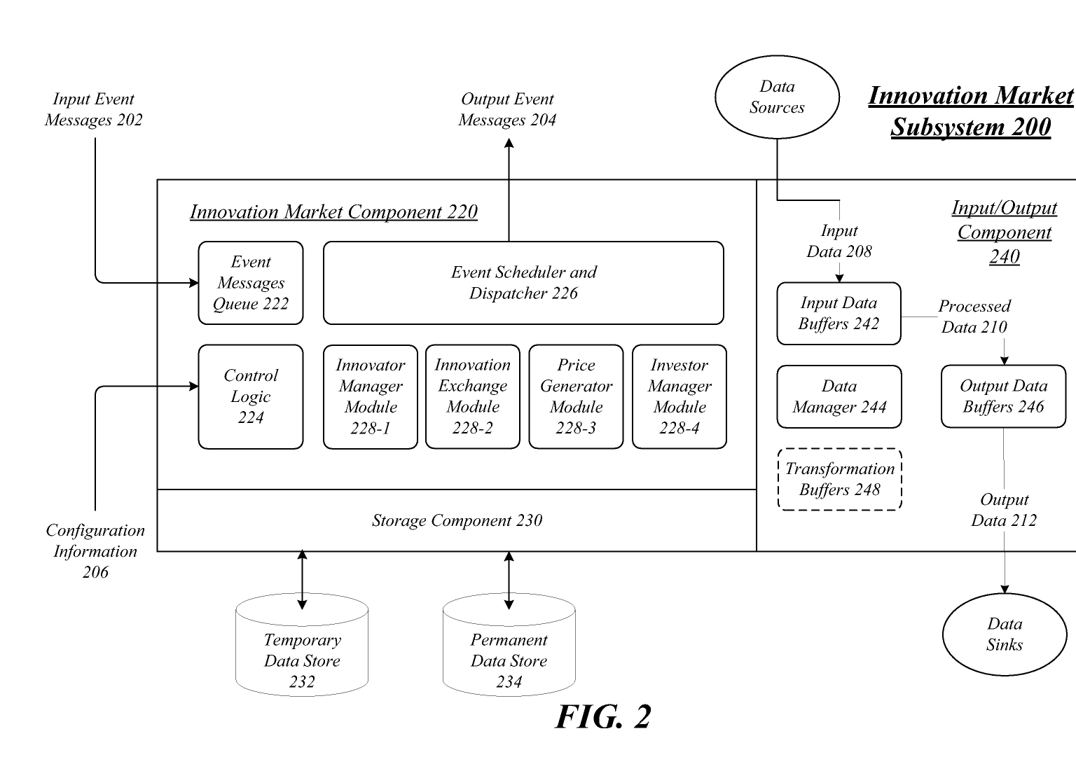

The computing system 120 and/or the communications system 140 may include an innovation market subsystem 200. The innovation market subsystem 200 may implement one or more innovation market techniques described in the various embodiments. In one embodiment, for example, the innovation market subsystem 200 may receive the signals 104 from a client node 102 over the communications media 106, process the signals 104 to generate an innovation marketplace, and send the signals 114 to one or both of the client nodes 102, 112. Additional details for the innovation market subsystem 200 may be described with reference to FIG. 2.

FIG. 2 illustrates an embodiment of the innovation market subsystem 200. The innovation market subsystem 200 may comprise multiple components and/or modules. In the illustrated embodiment shown in FIG. 2, the innovation market subsystem 200 may include an innovation market component 220, a storage component 230, and an input/output (I/O) component 240. The components and/or modules may be implemented using hardware elements, software elements, or a combination of hardware elements and software elements. Although the innovation market subsystem 200 as shown in FIG. 2 has a limited number of elements in a certain topology, it may be appreciated that the innovation market subsystem 200 may include more or less elements in alternate topologies as desired for a given implementation.

The innovation market component 220 may be arranged to receive various input event messages 202 at an event message queue 222. The event message queue 222 may comprise one or more queues for handling event messages. In one embodiment, for example, the event message queue 222 may handle event messages with distinct priorities. Examples of event messages 202 may include without limitation project submission events, buy request events, sell request events, positive market events, negative market events, portfolio management events, project management events, innovator events, investor events, and any other innovation market information communicated from external entities such as the client nodes 102, 112.

The innovation market component 220 may include control logic 224. The control logic 224 may be arranged to control operations of the innovation market component 220 based on configuration information 206. For example, the control logic 224 may execute an algorithm, logic flow or a state machine to perform various operations on input data 208 in response to the various input event messages 202. The control logic 224 may process the input data 208 based on the configuration information 206 to form processed data 210. The control logic 224 may also generate various output event messages 204, and send the output event messages 204 to an event scheduler and dispatcher 226.

The innovation market component 220 may include an event scheduler and dispatcher 226. The event scheduler and dispatcher 226 may be arranged to initiate events to other external entities, and dispatches internal events and messages within the innovation market component 220. For example, the event scheduler and dispatcher 226 may send various output event messages 204 responsive to the input event messages 202 to other systems, subsystems, components or modules for the systems 120, 140, the innovation exchange server node 110, and/or the network 100. Examples for output event messages 204 may include without limitation project submission acknowledgement events, buy confirmation events, sell confirmation events, market price events, positive market events, negative market events, portfolio management events, project management events, innovator events, investor events, and any other innovation market information communicated to external entities such as the client nodes 102, 112.

In one embodiment, the innovation market subsystem 200 may include the storage component 230. The storage component 230 may be arranged with data stores and logic to manage storage operations for information used by the innovation market component 220. The storage component 230 may store temporary or non-transacted information used by the innovation market component 220 in a temporary data store 232. For example, the temporary or non-transacted information may be stored as extensible markup language (XML), binary files, or some other format in the temporary data store 232. The storage component 230 may store persistent or transacted information used by the innovation market component 220 in a permanent data store 234. The data stores 232, 234 may comprise individual data stores, respectively, or multiple data stores comprising part of a larger data store array, such as a storage area network (SAN). Furthermore, the storage component 230 and the data stores 232, 234 may implement the appropriate data buffering and caching techniques and structures if needed to meet system latency and capacity parameters. The storage component 230 also manages operations for logging and auditing storage.

In one embodiment, the innovation market subsystem 200 may include the I/O component 240. The I/O component 240 may be arranged with buffers and logic to manage transport and I/O operations in moving information throughout the innovation market subsystem 200. For example, the I/O component 240 may include one or more input data buffers 242 to receive and store input data 208 from a data source. One or more modules of the innovation market component 220 may process the input data 208 to form processed data 210, and send it to one or more output data buffers 246. The output data buffers 246 may be arranged to store and send output data 212 to an output subsystem. A data manager 244 may implement logic and network interfaces (e.g., web service interfaces) to control and manage data collection services and data distribution services. Optionally, the I/O component 240 may implement one or more transformation buffers 248 to transform the input data 208 and/or the processed data 210 from one format, data schema or protocol, to alternate formats, data schemas, or protocols.

In general operation, the innovation market subsystem 200 may be arranged to implement various innovation market techniques. More particularly, the innovation market subsystem 200 may create and manage a public or private innovation market exchange for multiple projects to facilitate measurement or prediction of project values to an organization, such as a business entity. In one embodiment, for example, the innovation market subsystem 200 may manage an innovation marketplace for the exchange of virtual shares in a project for virtual currency to measure project value. This may be accomplished using a number of innovation modules 228-1-p. In the illustrate embodiment shown in FIG. 2, the innovation modules 228-1-p may include an innovator manager module 228-1, an innovation exchange module 228-2, a price generator module 228-3, and an investor manager module 228-4. Although a specific number of innovation modules 228-1-p are shown in FIG. 2 by way of example and not limitation, it may be appreciated that more or less modules may be implemented for various sets of innovation market operations as desired for a given implementation. The embodiments are not limited in this context.

The innovator manager module 228-1 may be generally operative to manage projects and provide innovator services for the innovation market. As used herein, the term “project” may generally refer to a discrete unit of work. Examples of a project may include without limitation ideas, concepts, inventions, tasks, operations, features, products, services, resources, information types, data units, and any other measurable units of work. An innovator may comprise an individual entity that authors, produces, generates or otherwise submits a project for inclusion in the innovation marketplace. Innovator services may include without limitation account management, evaluating project proposals, virtual share allocations, project valuations, project resource allocations, and so forth.

The innovator manager module 228-1 may be operative to allocate virtual shares to a project. A share typically refers to a discrete unit of account for a project. In a conventional sense, a unit of account is a standard monetary unit of measurement of the market value/cost of goods, services, or assets. A standard unit of account allows meaningful interpretation of prices, costs, and profits, so that an entity can monitor its own performance and its shareholders can make sense of its past performance and have an idea of its future profitability. As used herein, the term “virtual share” may generally refer to a non-monetary unit of account. In other words, a virtual share does not represent a financial interest or ownership interest in a project. Rather, a virtual share allows innovators to divide a project into discrete measurable units or portions suitable to apply stock market principles to measure an overall value for a project or community interest in a project.

The innovator manager module 228-1 may allocate a variable number of virtual shares to a project for innovators to exchange with investors for virtual currency. Through the innovation marketplace, innovators may offer for “sale” virtual shares in a particular project. Investors may then “buy” virtual shares in a particular project using virtual currency from the innovators, or other investors currently owning virtual shares in a project.

The innovator manager module 228-1 is generally operative to manage projects and provide innovator services for one broad category of market participants, such as innovators. Similarly, the investor manager module 228-4 is generally operative to manage investment portfolios and provide investor services for another broad category of market participants, such as investors. An investor may comprise an individual entity that buys, sells or otherwise trades virtual shares of a project as part of an investment portfolio. In contrast to an innovator who submits a project, an investor buys and sells virtual shares for a project using virtual currency. Investor services may include without limitation account management, project analysis tools, investment tools, virtual share management, virtual currency management, investment portfolio management, profit/loss statements, and so forth.

The investor manager module 228-4 may be operative to allocate virtual currency to investors to exchange with innovators for virtual shares in projects. A currency is a unit of monetary exchange to facilitate transfer of goods and/or services. It is one form of money, where money is anything that serves as a medium of exchange, a store of value, and a standard of value. A currency is typically the dominant medium of exchange for commercial transactions, including buying and selling shares of stock in a stock market. As used herein, the term “virtual currency” is a non-monetary unit of exchange. In other words, virtual currency does not represent a financial or monetary medium of exchange. Rather, virtual currency allows investors to buy and sell virtual shares in a project, with increases to virtual currency correlating to a higher project value, portfolio value or project investment acumen, and decreases to virtual currency correlating to lower project value, portfolio value or project investment acumen.

The innovation exchange module 228-2 is communicatively coupled to the project manager module 228-1. More particularly, the innovation exchange module 228-2 may be operative to exchange virtual shares for virtual currency at a virtual market price. The innovation exchange module 228-2 implements a core market exchange engine for the innovation market. The innovation exchange module 228-2 provides a platform for innovators and/or investors to list virtual shares for projects in an online electronic innovation marketplace where the virtual shares, virtual market price for the virtual shares, and project identifiers, among other relevant information, are available for viewing by private or public members of the innovation market. The innovators and/or investors may then exchange or trade virtual shares for virtual currency at agreed upon virtual market prices.

In some cases, the innovators and/or investors may exchange or trade virtual shares for virtual currency among each other in an auction model that is similar to a traditional stock market. In an auction model, the innovation exchange module 228-2 may implement a matched bargain or order driven technique to match buyer orders with seller orders. When the innovation exchange module 228-2 determines that a buyer order matches a seller order at a virtual market price, it completes a trade between the buyer and the seller. This may provide a more precise measure of project value among a community of investors, which may be desirable for larger investor communities with higher trade volumes. This may also create a need for a willing counter-party to complete a transaction, however, which may be undesirable for investor communities with smaller trade volumes, such as start-up investor communities or investor communities for smaller organizations.

In other cases, the innovators and/or investors may exchange or trade virtual shares for virtual currency in a market maker model. In a stock market, a market maker is an entity that quotes both a buy and a sell price in a financial instrument or commodity, hoping to make a profit on the turn or the bid/offer spread. A client's loss results in a profit for the market maker, and vice versa. Similarly, the innovation exchange module 228-2 may implement an electronic innovation market maker that offers both a buy price and a sell price for virtual shares. When an innovator and/or investor desires to buy virtual shares in a project using virtual currency, the electronic innovation market maker may complete the trade at the current sell price. Similarly, when an innovator and/or investor desires to sell virtual shares in a project using virtual currency, the electronic innovation market maker may complete the trade at the current buy price. Unlike a market maker in a stock market, however, the electronic innovation market maker is not attempting to necessarily “profit” from offer market making services, but rather allowing an innovator and/or investor to readily buy or sell virtual shares in a project without the need for a willing counter-party to the transaction.

The price generator module 228-3 is communicatively coupled to the innovation exchange module 228-2. The price generator module 228-3 may be operative to modify a virtual market price for a project based on a completed trade or exchange of virtual shares for the project and virtual currency. The price generator module 228-3 may generate and modify virtual market prices for a project in different ways depending on the market exchange model implemented for the innovation exchange module 228-2.

In the auction model, for example, the price generator module 228-3 may generate a virtual market price for virtual shares of a project based on the last trade made for the virtual shares. Additionally or alternatively, the price generator module 228-3 may generate a virtual market price based on a volume of buyer orders and seller orders for virtual shares in a project at any given point in time, as represented by buyer bids and seller asks.

In a market maker model, for example, the price generator module 228-3 may generate a virtual market price in an algorithmic manner by implementing various price modifying functions. The price modifying functions may be mathematically designed to increase or decrease a virtual market price based on completed trades. In one embodiment, for example, the innovation exchange module 228-2 may implement a price increase function to control increases for a virtual market price for virtual shares in a project, and a price decrease function to control decreases for a virtual market price for virtual shares in a project.

The price generator module 228-3 may be arranged to increase the virtual market price in response to a defined set of price increase events that increase the underlying value for a project. Examples for price increase events include without limitation when an investor buys virtual shares in the project, a positive market event occurs for the project, resources are allocated to a project, recognition or awards are given for the project, positive news for a project, and so forth. The price increase events may in general attempt to simulate or capture those events that would normally cause a stock price for a company listed on a public stock market exchange to increase. The embodiments, however, are not limited to these examples.

The price generator module 228-3 may be arranged to decrease the virtual market price in response to a defined set of price decrease events that decrease the underlying value for a project. Examples for price decrease events may include without limitation when an investor sells virtual shares in the project, a negative market event occurs for the project, resources are deallocated from a project, negative news for a project, and so forth. As with the price increase events, the price decrease events may in general attempt to simulate or capture those events that would normally cause a stock price for a company listed on a public stock market exchange to decrease. The embodiments, however, are not limited to these examples.

In one embodiment, the price generator module 228-3 may implement a price increase function arranged to generate virtual share appreciation based on the number of virtual shares that are held or in the possession of investors as this represents a level of interest or confidence that the investor community has in the project. By way of example, assume the virtual shares for a project are allocated an initial virtual market price of $20 of the virtual currency. Assume a first investor purchases 10 shares at $20 which then increases the share price by $1 to $21. Another investor then purchases 10 shares at $21 which then increases the share price by another $1. As the project progresses, its virtual market price for the virtual shares will increase as more investors express their interest and buy into the project.

Similarly, a project may also decline should it fail to show progress. In this event, investors may withdraw their interest in the project by selling their virtual shares back to the electronic innovation market maker or another investor. The virtual market price then declines by the same factor by which it appreciated. So if the investor sells back 10 shares when the share price of the project is $30 virtual dollars, then the virtual market price for the virtual shares drops to $29.

This is a basic example which can be mathematically or strategically refined based on research into existing virtual markets, betting schemes, or an options pricing formula, such as the Black-Scholes model. The Black-Scholes model was the first quantitative technique to comprehensively and accurately estimate the price for a variety of simple option contracts. Any number of price modifying functions can be defined. In one embodiment, the price modifying function design should attempt to address the following considerations: (1) the price modifying function should be sufficiently clear for all community members to understand; (2) the price modifying function should be capable of execution without reaching a critical mass of users; (3) easy to implement and maintain; and (4) not easily gamed. With respect to the second consideration, for example, the price modifying function should provide the ability to buy shares in a project without someone else wanting to sell shares (e.g., the market maker model). With respect to the third consideration, a level of mathematical preciseness for a price modifying function should be weighed against implementation time and performance when trade volume declines. With respect to the fourth consideration, while it is virtually impossible to prevent someone from gaming any system, the price modifying function should not offer any obvious opportunities for individuals to take advantage of the pricing/betting scheme.

The investor manager module 228-4 is communicatively coupled to the price generator module 228-3. The inventor manager module 228-4 may be operative to generate a project value for an investor by multiplying the virtual market price for the virtual shares and a number of virtual shares owned by the investor. The inventor manager module 228-4 may also generate a portfolio value for an investor by summing multiple project values for a portfolio of projects. The project value and portfolio value represent indicators or scores regarding investment success for a project investor. One goal of the innovation market is identify those investors capable of predicting the success or failure of a project. The project value and portfolio value provide an objective measurement that may be compared to other investors.

At a project level, the investor manager module 228-4 may aggregate project values for all investors to measure a total project value for the entire project. In this manner, an innovator or other business decision maker may use the total project value for each project to make informed business decisions by statistically ranking the projects by total project values.

At a community level, the investor manager module 228-4 may aggregate portfolio values for all investors to measure a total portfolio value for the entire community. In this manner, a business decision maker may use the total portfolio value to make informed business decisions regarding the level of community participation in the project submission, evaluation and planning process.

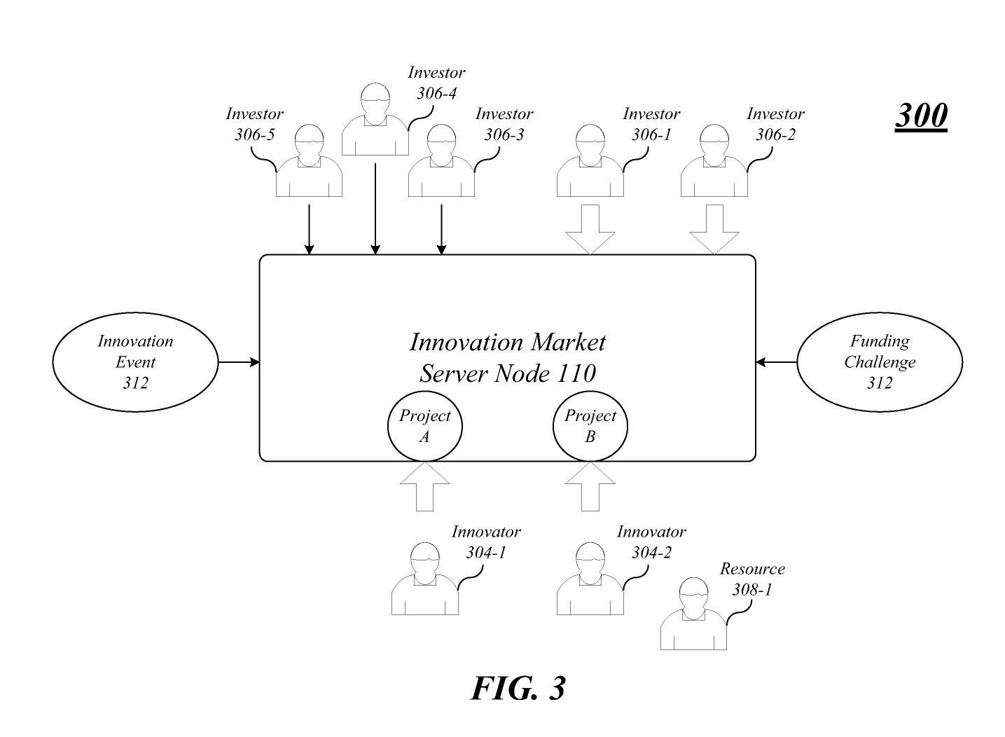

FIG. 3 illustrates a logic diagram for an innovation market 300. The innovation market 300 may include the innovation market server node 110 communicatively coupled to various client nodes used by various investors various innovators 304-1-r and investors 306-1-s.

The innovation market server node 110 allows individuals and team to list projects in the innovation market 300. Once listed, the project is issued virtual shares and a virtual market price for the virtual shares which can be purchased by market participants. Upon registration, the investors 306-1-s are allocated virtual currency, such as virtual dollars, that can be used to purchase shares in the various listed projects. Since one goal for the investors 306-1-s is to build the most valuable portfolio of projects, the investors 306-1-s will seek projects they believe have the best opportunity for growth based on many different project factors. Examples of project factors may include without limitation how well the project is presented or “sold” to the investors 306-1-s, how novel is the project, who is behind or involved with the project, what level of progress has the project achieved, how well the project is run, whether the project is picked up by a product team, and so forth.

The innovation market 300 may help an organization realize various goals and advantages. More particularly, the innovation market 300 may assist the innovators 304-1-r and investors 306-1-s in a number of different ways, such as: helping innovators 304-1-r to promote, build, and refine their projects; draw employees into the greater innovation eco-system who would otherwise not consider themselves entrepreneurs or innovators; help product teams in their innovation process and technology transfer from innovation groups; identify ideas, projects, and features in which innovation and product teams should invest; change employee perception of an innovation culture for an organization, change shareholder and customer perception of an innovation culture for an organization, and so forth.

Referring to the illustrated embodiment shown in FIG. 3, assume the innovator manager module 228-1 of the innovation market component 220 receives a first request from an individual innovator 304-1 to list a Project A for the innovation market 300, and a second request from an product group team innovator 304-2 to list a Project B for the innovation market 300. Further assume that the price generator module 228-3 generates an initial virtual market price for the virtual shares of both Projects A, B as $20 per virtual share.

Once the Projects A, B are listed by the innovation market 300, assume an individual investor 306-1 views the virtual market prices for the Projects A, B, and decides to invest $500 virtual currency in each of the Projects A, B. The individual investor 306-1 may send an input event message 202 in the form of a buy request to buy 25 virtual shares from each of the Projects A, B for $20 per virtual share. The innovation exchange module 228-2 may receive the buy request, execute the trade, and send a buy confirmation in the form of an output event message 204 to the individual investor 306-1. The innovation exchange module 228-2 may output a trade confirmation to the price generator module 228-3.

The price generator module 228-3 may receive the trade confirmation, and modify the initial virtual market price for both Projects A, B from $20 to a current virtual market price of $22 for both Projects A, B. The price generator module 228-3 may output the current virtual market price of $22 to the investor manager module 228-4, and also the individual investor 306-1 in the form of an output event message 204 or output data 212.

The investor manager module 228-4 may receive the current virtual market price of $22 for the Projects A, B. The investor manager module 228-4 may then generate a project value of $1100 for the investor 306-1 by multiplying the virtual market price of $22 for the virtual shares by the 25 virtual shares owned by the individual investor 306-1.

Continuing with this example, assume other investors 306-3, 306-4, 306-5 decide to purchase virtual shares for the Projects A, B. Further assume that their level of investment of virtual currency in the virtual shares causes the virtual market prices for the virtual shares of Projects A, B to increase to $30, $32, respectively. The investor manager module 228-4 generates a new project value of $1550 by multiplying the virtual market prices of $30, $32 for the virtual shares of respective Projects A, B by the 25 virtual shares owned by the individual investor 306-1. At this point, the individual investor 306-1 has an unrealized return of approximately 55%.

Assume a new resource 308-1 joins the product group team innovator 304-2 that listed Project B for the innovation market 300. The innovation market component 220 may receive notification of the new resource 308-1 via an input event message 202. The price generator module 228-3 may receive the notification of a resource event, calculate the impact of the additional resource on the virtual market price for Project B, and increase the virtual market price from $32 to $38 to reflect the additional value added to Project B by the new resource 308-1. The investor manager module 228-4 may update the project value from $1550 to $1750 to reflect the current virtual market price for Project B.

Assume an innovation event 310 occurs for Project A. The innovation event 310 may comprise, for example, a product release or some other project milestone. The innovation market component 220 may receive notification of the innovation event 310 via an input event message 202. The price generator module 228-3 may receive the notification of the innovation event, calculate the impact of the innovation event on the virtual market price for Project A, and increase the virtual market price from $32 to $38 to reflect the additional value added to Project A by the innovation event 310. The investor manager module 228-4 may update the project value from $1750 to $1900 to reflect the current virtual market price for Project A.

Assume an investor 306-2 is an executive from the organization who decides to enter the innovation market 300 and provide a funding challenge 312 for the Projects A, B. The innovation market component 220 may receive notification of the funding challenge 31 via an input event message 202. The price generator module 228-3 may receive the notification of the funding challenge event, calculate the impact of the funding challenge event on the virtual market price for Projects A, B, and increase the virtual market price for Project A from $38 to $70 and the virtual market price for Project B from $38 to $90, to reflect the additional value added to Projects A, B by the funding challenge event 312. The investor manager module 228-4 may update the project value from $1900 to $4000 to reflect the current virtual market prices for Projects A, B. At this point, the individual investor 306-1 has an unrealized return of approximately 400%.

An organization may use the objectively measured results from the innovation market 300 to improve project planning for a fiscal year. For example, the organization that employs individual investor 306-1 may realize her ability to recognize and invest in higher value projects, and may therefore include the individual investor 306-1 in higher-level project planning operations. In another example, the organization may realize that Projects A, B have substantial promise, and therefore provide additional funding and/or resources to both Projects A, B. In yet another example, the organization may establish a communication channel with news of project updates for Projects A, B. In still another example, the organization may have games, contests or challenges to employees to determine who will have the most valuable investment portfolios.

The innovation market 300 may also be used to build and grow a social network or community of organization members. For example, the innovation market server node 110 may implement social networking application software providing social network operations for the innovation market 300. Investors could promote the projects that they hold virtual shares in as this will increase awareness and ultimately the virtual market price for the virtual shares of the project, such as telling other investors about a project they like, telling members of their social network about the innovation market and various projects, and so forth. Investors can also contribute to a project in order to help grow it, and thereby increase the value of their investment. This may be as include activities such as providing feedback on whether the project is well understood, actually contributing work to the project themselves, leveraging members of their own social network to contribute work to the project, and so forth. Investors can also create interest groups. Investors may form a group based on common interests such as a particular technology or an investment strategy. Investors can also create investment groups in order to pool portfolio holdings and compete against other investment groups. Investors can create the equivalent of a sports pool where members of the group compete against one another to earn “bragging” rights. Investors can earn additional investment dollars by using a referral tool to e-mail colleagues and tell them about the innovation market 300. Innovators can use a tool that creates an e-mail announcement to people who are invested in their project. These and other activities may contribute to growing the innovation market 300.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

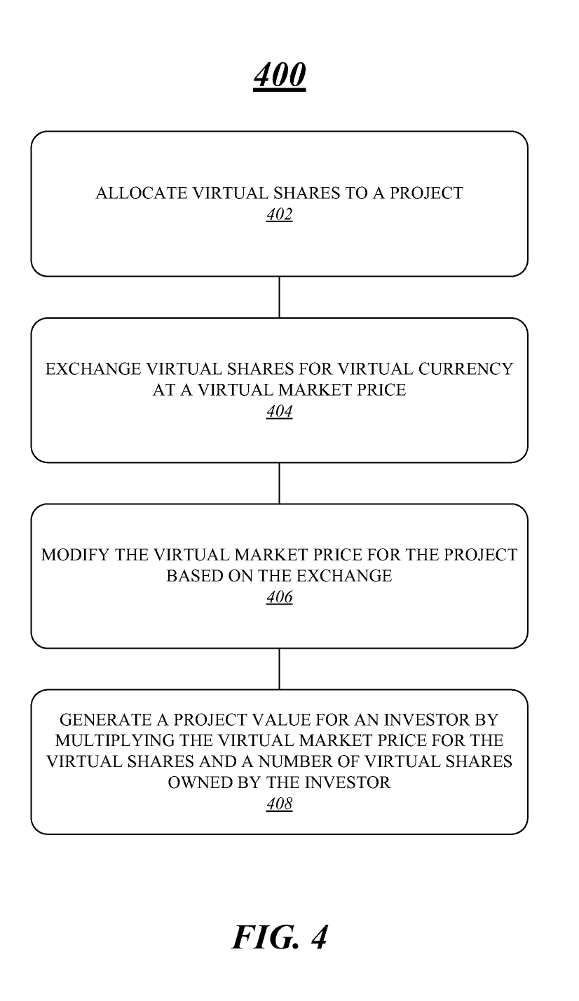

FIG. 4 illustrates one embodiment of a logic flow 400. The logic flow 400 may be representative of some or all of the operations executed by one or more embodiments described herein.

In the illustrated embodiment shown in FIG. 4, the logic flow 400 may allocate virtual shares to a project at block 402. For example, the innovator manager module 228-1 may allocate virtual shares to a Project A. The number of virtual shares allocated to a given project may be static or dynamic depending on the type of market exchange module implemented by the innovation exchange module 228-2.

The logic flow 400 may exchange virtual shares for virtual currency at a virtual market price at block 404. For example, the innovator exchange module 228-2 may exchange virtual shares for virtual currency at a virtual market price. The innovator exchange module 228-2 may use an auction model, a market maker model, or some other market exchange model.

The logic flow 400 may modify the virtual market price for the project based on the exchange at block 406. For example, the price generator module 228-3 may modify the virtual market price for the project based on the exchange or trade executed by the innovation exchange module 228-2. Additionally or alternatively, the price generator module 228-3 may modify the virtual market price for the project based on various positive or negative market events.

The logic flow 400 may generate a project value for an investor by multiplying the virtual market price for the virtual shares and a number of virtual shares owned by the investor at block 408. For example, the investor manager module 228-4 may generate a project value for an investor by multiplying the virtual market price for the virtual shares and a number of virtual shares owned by the investor. Additionally or alternatively, the investor manager module 228-4 may generate a portfolio value for an investor by summing multiple project values for a portfolio of projects.

FIG. 5 further illustrates a more detailed block diagram of computing architecture 510 suitable for implementing the innovation exchange server node 110. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more software programs 536-1-t and accompanying data. Depending on the implementation, examples of software programs 536-1-t may include a system program 536-1 (e.g., an operating system), an application program 536-2 (e.g., a web browser), the innovation market subsystem 200, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may be representative of, for example, the communications interfaces for the communications components 116-1-v. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

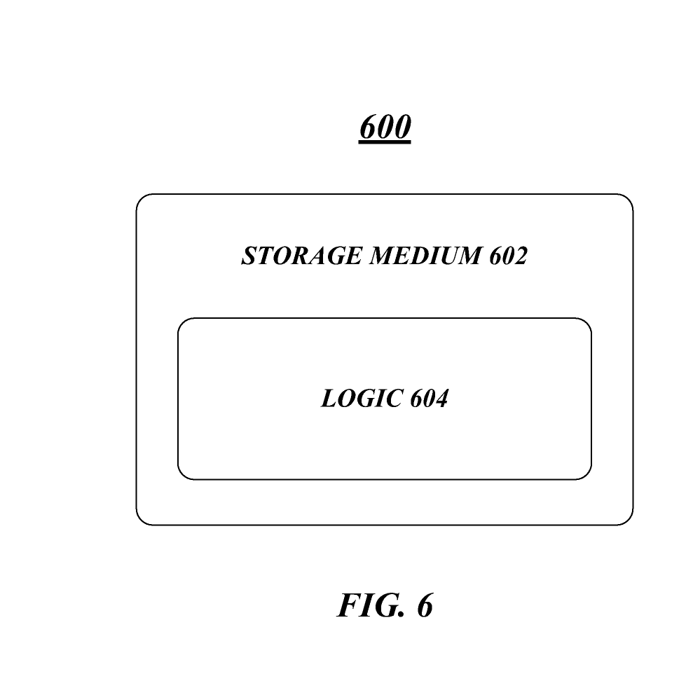

FIG. 6 illustrates a diagram an article of manufacture 600 suitable for storing logic for the various embodiments, including the logic flow 400. As shown, the article 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
allocating virtual shares to a project;
allocating virtual shares to innovators to exchange with investors for virtual currency;
exchanging virtual shares for virtual currency at a virtual market price;
modifying the virtual market price for the project based on the exchange; and
generating a project value for an investor by multiplying the virtual market price for the virtual shares and a number of virtual shares owned by the investor.

2. (canceled)

3. The method of claim 1, comprising allocating virtual currency to investors to exchange with innovators for the virtual shares.

4. The method of claim 1, comprising increasing the virtual market price when an investor buys virtual shares in the project based on a price increase function.

5. The method of claim 1, comprising increasing the virtual market price when a positive market event occurs for the project based on a price increase function.

6. The method of claim 1, comprising decreasing the virtual market price when an investor sells virtual shares in the project based on a price decrease function.

7. The method of claim 1, comprising decreasing the virtual market price when a negative market event occurs for the project based on a price decrease function.

8. The method of claim 1, comprising promoting the project to potential investors with virtual currency.

9. The method of claim 1, comprising contributing to the project from potential investors with project ideas.

10. The method of claim 1, comprising generating a portfolio value for an investor by summing multiple project values for a portfolio of projects.

11. An article comprising a storage medium containing instructions that if executed enable a system to:
allocate virtual shares to a project based on an estimated project value;
allocate virtual shares to innovators to exchange with investors for virtual currency;
exchange virtual shares for virtual currency at a virtual market price;
modify the virtual market price for the project based on the exchange; and
generate a project value for an investor by multiplying the virtual market price for the virtual shares and a number of virtual shares owned by the investor.

12. The article of claim 11, further comprising instructions that if executed enable the system to allocate virtual currency to investors to exchange with innovators for the virtual shares.

13. The article of claim 11, further comprising instructions that if executed enable the system to increase the virtual market price when an investor buys virtual shares in the project, or a positive market event occurs for the project, based on a price increase function.

14. The article of claim 11, further comprising instructions that if executed enable the system to decrease the virtual market price when an investor sells virtual shares in the project, or a negative market event occurs for the project, based on a price decrease function.

15. The article of claim 11, further comprising instructions that if executed enable the system to generate a portfolio value for an investor by summing multiple project values for a portfolio of projects.

16. An apparatus, comprising:
an innovation market subsystem to manage an innovation marketplace for the exchange of virtual shares in a project for virtual currency to measure project value, the innovation market subsystem comprising:
an innovator manager module operative to allocate virtual shares to a project and allocate virtual shares to innovators to exchange with investors for virtual currency;
an innovation exchange module communicatively coupled to the project manager module, the innovation exchange module operative to exchange virtual shares for virtual currency at a virtual market price;
a price generator module communicatively coupled to the innovation exchange module, the price generator module operative to modify the virtual market price for the project based on the exchange; and
an investor manager module communicatively coupled to the price generator module, the inventor manager module operative to generate a project value for an investor by multiplying the virtual market price for the virtual shares and a number of virtual shares owned by the investor.

17. The apparatus of claim 16, the investor manager module operative to allocate virtual currency to investors to exchange with innovators for the virtual shares.

18. The apparatus of claim 16, the price generator module to increase the virtual market price when an investor buys virtual shares in the project, or a positive market event occurs for the project, based on a price increase function.

19. The apparatus of claim 16, the price generator module to decrease the virtual market price when an investor sells virtual shares in the project, or a negative market event occurs for the project, based on a price decrease function.

20. The apparatus of claim 16, comprising an innovation market server node having a computing system, the computing system implementing the innovation market subsystem.
